(19) United States
(12) Patent Application Publication
(10) Pub. No.: US 2024/0351114 A1
(43) Pub. Date: Oct. 24, 2024

(54) MACHINING TOOL, CUTTING INSERT HOLDER AND CUTTING INSERT

(71) Applicants: Schneider GmbH & Co. KG, Fronhausen (DE); Hartmetall-Werkzeugfabrik Paul Horn GmbH, Tuebingen (DE)

(72) Inventors: Ferdinand ACHENBACH, Breidenbach-Wolzhausen (DE); Tobias KEMMLER, Pliezhausen (DE)

(21) Appl. No.: 18/686,051

(22) PCT Filed: Aug. 31, 2022
(86) PCT No.: PCT/EP2022/074184

§ 371 Date: Feb. 23, 2024

(30) Foreign Application Priority Data
Aug. 31, 2021 (DE) 10 2021 122 424.1

(51) Int. Cl. B23B 27/16

(52) U.S. Cl. CPC B23B 27/16

(57) ABSTRACT

Tool for machining a workpiece, comprising: a cutting insert; and a cutting insert holder comprising a first cutting insert receptacle extending along a first center axis and a second cutting insert receptacle extending along a second center axis, into which the cutting insert is selectively receivable; wherein the first and second center axes intersect at an imaginary crossing point located in a region that is covered by the cutting insert when the cutting insert is received in the first cutting insert receptacle as well as when the cutting insert is received in the second cutting insert receptacle.

### CROSS-REFERENCE TO RELATED APPLICATIONS

This application is a national stage application under 35 U.S.C. 371 of PCT Application No. PCT/EP2022/074184, having an international filing date of 31 Aug. 2022, which designated the United States, which PCT application claimed the benefit of German Patent Application No. 10 2021 122 424.1, filed 31 Aug. 2021, each of which are incorporated herein by reference in their entirety.

### BACKGROUND

The present invention relates to a tool for machining, in particular (shape) cutting, a workpiece. Further, the present invention relates to a cutting insert holder for such a tool. In addition, the present invention relates to a cutting insert.

Tools of this type can be used for precision machining of workpieces of various materials, such as metal, plastic or glass. Typically, these tools are used in CNC fully automatic machines.

Particularly preferably, the tool according to the invention is a turning tool. Such turning tools are usually of multi-part construction and have a cutting insert holder with a cutting insert that can be interchangeably mounted therein. The tool can be used, for example, for manufacturing spectacle lenses, in particular made from plastic.

When machining a spectacle lens, there are very high precision requirements. The cutting edge provided on the cutting insert must therefore be manufactured very precisely. For this reason, and due to the material properties of glass or plastic, cutting edges made of diamond are typically used for such machining tools.

However, cutting edges made of diamond are very expensive. In addition, the service lives of such cutting inserts with diamond cutting edges are comparatively short, since the diamond cutting edges wear out quickly or at least can no longer be used for the high-precision machining of spectacle lenses after just a few machining cycles. This leads to high tool costs and thus also to high manufacturing costs of spectacle lenses.

DE 10 2009 040 075 B4 relates to an apparatus for turning machining optical workpieces made of non-brittle-hard materials, in particular plastic spectacle lenses. The apparatus comprises a holder to which a carrier with a cutting edge can be fixed. The carrier can be fixed in two different positions on the holder in order to be able to use different circumferential portions of the circular arc-shaped cutting edge for machining. For this purpose, the carrier has two stop surfaces arranged at an obtuse angle and the holder has a flat mating surface. The two different positions are realized depending on which stop surface is in contact with the mating surface.

It should be noted that the aforementioned example of the manufacture of spectacle lenses is only one of many possible exemplary uses of the tool according to the invention, on the basis of which the underlying problem can be explained in a particularly comprehensible manner.

### SUMMARY

It is a task of the present invention to provide an improved tool for machining a workpiece, which has a particularly simple and/or compact structure and/or can be manufactured in a cost-and/or resource-efficient manner and/or in which a cutting insert is or can be positioned in a particularly simple manner on a cutting insert holder in a defined manner. It is further a task to provide a corresponding cutting insert holder for such a tool. It is also a task to specify a cutting insert that can be attached to a cutting insert holder in a particularly simple and defined manner and/or that has a compact design/structure.

According to a first aspect of the present invention, the above-mentioned task is solved by a tool for machining, in particular (shape) cutting, a workpiece, in particular an optical workpiece, for example a spectacle lens, wherein the tool has a cutting insert and a cutting insert holder which has a first cutting insert receptacle running along a first center axis and a second cutting insert receptacle running along a second center axis, into which the cutting insert is selectively receivable, in particular insertable. The first and second center axes intersect at an imaginary crossing point located in an area/region that is covered by the cutting insert both when the cutting insert is received or inserted in the first cutting insert receptacle and when the cutting insert is received or inserted in the second cutting insert receptacle. This imaginary crossing point is preferably located outside the cutting insert holder.

According to a second aspect of the present invention, the above-mentioned task is solved by a cutting insert holder for such a tool, the cutting insert holder having a first cutting insert receptacle extending along a first center axis for receiving a cutting insert and a second cutting insert receptacle extending along a second center axis for receiving the cutting insert. The first center axis and the second center axis are aligned at an acute angle to one another and intersect at an imaginary crossing point, so that the cutting insert is receivable, in particular insertable, selectively in the first cutting insert receptacle or in the second cutting insert receptacle. The imaginary crossing point is preferably located outside the cutting insert holder.

The cutting insert holder used in the tool according to the invention is thus designed as a double cutting insert holder. Simultaneous insertion of two cutting inserts into the cutting insert holder is preferably prevented by the geometry or design of the cutting insert holder and/or cutting insert. Instead, a cutting insert can be inserted either into the first cutting insert receptacle or into the second cutting insert receptacle.

Simultaneous insertion of two cutting inserts into the two cutting insert receptacles is not possible because the two cutting insert receptacles are oriented obliquely or at an angle to each other such that their center axes intersect at an imaginary crossing point located in the area/region covered by the cutting insert both when it is received or inserted into the first cutting insert receptacle and when the cutting insert is received or inserted into the second cutting insert receptacle.

Preferably, therefore, the cutting insert is fixable in two different positions on the cutting insert holder, the positions in particular pivoted relative to one another about the crossing point, by selectively receiving it in one of the two cutting insert receptacles.

In practice, the two cutting insert receptacles are used sequentially, i.e. one after the other. First, the cutting insert is fixed/clamped in one cutting insert receptacle and the tool is used/the workpiece is machined in this cutting insert position. As soon as a part of the cutting portion or cutting edge of the cutting insert is worn, the cutting insert is then fixed/clamped in the other cutting insert receptacle. When the cutting insert is repositioned/reclamped, it is automatically brought into a pivoted/tilted position due to the inclination of the two cutting insert receptacles relative to each other. This results in a pivoted/tilted position of the cutting portion or cutting edge of the cutting insert. In the new cutting insert position, the workpiece can therefore then be further machined with another part of the cutting portion or cutting edge.

In this way, the service life of the cutting insert can be almost doubled. For this, the cutting insert only has to be reclamped once (e.g. after half the time) in the cutting insert holder. This can be done quickly and easily. The cost reduction that results from this is immense.

Preferably, the two cutting insert receptacles are designed and arranged relative to each other in such a way that reclamping the cutting insert from one cutting insert receptacle to the other does not result in a change of the tip height, but only in a repositioning of the cutting insert. In particular, after reclamping or repositioning, the cutting insert is in a second position that is pivoted relative to the first position.

In other words, the reclamping of the cutting insert preferably results only in a rotation of the cutting portion or cutting edge of the cutting insert about a defined point, but in no or at least only a slight translation of the cutting portion or cutting edge. For the reclamping itself, however, a translatory movement is preferably necessary, for example pulling the cutting insert out of the first cutting insert receptacle and inserting it into the second cutting insert receptacle.

After reclamping the cutting insert, only minor position adjustments of the cutting insert holder, e.g. a marginal adjustment of the tip height, are necessary, if at all. The workpiece can thus be machined further very quickly with the second part of the cutting portion or cutting edge after reclamping the cutting insert.

For example, in the first cutting insert position (cutting insert clamped in the first cutting insert receptacle), the workpiece is machined with a first part/segment of the cutting portion or cutting edge of the cutting insert, and in the second cutting insert position (cutting insert inserted in the second cutting insert receptacle), the workpiece is machined with a second part/segment of the cutting portion or cutting edge.

The two cutting parts mentioned can be separate sectors, i.e. separate subsections, of one and the same cutting portion. However, the at least one cutting portion can also have a plurality of partial cutting portions that are arranged separately from one another or merge into one another. In the latter case, the workpiece would first be machined with the one partial cutting portion or a cutting edge thereof and then be machined with the other partial cutting portion or cutting edge thereof. Various designs are possible here.

The provision of two cutting insert receptacles on the cutting insert holder is particularly advantageous here, as this enables a particularly simple change of the position of the cutting insert. In addition, the cutting insert can be made very compact. This is particularly advantageous because the cutting insert, as a wearing part, has to be replaced more frequently and a compact structure is therefore more resource-efficient.

Furthermore, the two cutting insert receptacles on the cutting insert holder allow the different positions of the cutting insert to be specified very precisely and in a defined manner. In particular, it can be ensured that a new part/segment of the cutting portion or cutting edge to be used is positioned as precisely as possible in the same place as the previously used part/segment of the cutting portion or cutting edge after changing the cutting insert receptacle. This enables high-precision machining, the accuracy of which can be in the micrometer range.

According to a preferred embodiment, the first cutting insert receptacle is designed as a first receiving pocket into which the cutting insert can be inserted along the first center axis from a front side of the cutting insert holder. According to this embodiment, the second cutting insert receptacle is preferably designed as a second receiving pocket, into which the cutting insert can be inserted along the second center axis from the front side of the cutting insert holder.

This allows for easy changing of the cutting insert. At the same time, a mechanically stable and secure clamping of the cutting insert in the cutting insert holder can be realized.

In this embodiment, the cutting insert or at least its insertion portion or clamping portion, i.e. the portion that is received or clamped in the cutting insert receptacle, is preferably elongated or rod-shaped. The cutting insert receptacles or receiving pockets are preferably shaped accordingly as elongated depressions or recesses or bores. This enables particularly easy introduction or insertion and stable and secure clamping.

Particularly preferably, the cutting insert receptacles or receiving pockets are non-round, in particular polygonal, in a section transverse to their longitudinal axes. The cutting insert or clamping portion preferably has a corresponding non-round, in particular polygonal, cross-section and/or a corresponding non-round, in particular polygonal, outer contour, and/or is correspondingly designed as a prism. This enables particularly secure and stable clamping in a defined position. In particular, self-centering can also be realized in this way, so that the cutting insert automatically assumes a defined position during or as a result of the clamping.

In an alternative embodiment, the cutting insert receptacles are designed as recesses on an upper side of the cutting insert holder, into each of which the cutting insert can be inserted from above. This allows for easy changing of the cutting insert.

The recesses are preferably V-shaped. The cutting insert preferably has a corresponding V-shaped outer contour at least in parts. The V-shape enables defined positioning, in particular self-centering, of the cutting insert. In this embodiment, the cutting insert is preferably designed as an in particular diamond-shaped cutting plate.

Particularly preferably, the recesses partially overlap, in particular in such a way that a W-shaped receptacle region is formed by the respective V-shaped recesses. This realizes a compact structure of the cutting insert holder. In addition, the cutting insert can also be constructed to be correspondingly compact.

The further preferred embodiments/configurations described below preferably apply generally to a tool according to the invention and are not limited to the above preferred embodiments/configurations with receiving pockets, V-shaped recesses or the like, unless otherwise indicated.

The two cutting insert receptacles are preferably shaped identically to each other.

This has the advantage that no changes in the machining properties result from the repositioning of the cutting insert from one cutting insert receptacle to the other. The positioning of the cutting insert is automatically predetermined by the shape of the cutting insert receptacles and is implemented in the same way in both cutting insert receptacles.

The first center axis and the second center axis are preferably aligned at an acute angle to each other. Particularly preferably, the acute angle is less than or equal to 60°. Depending on the embodiment, the acute angle can also be smaller than or equal to 40° or 35°.

The angle by which the cutting portion or cutting edge is pivoted after the cutting insert has been repositioned/reclamped corresponds to the angle between the two center axes of the cutting insert receptacles.

According to a further embodiment/configuration, the cutting insert has a cutting portion with at least one cutting edge, wherein the at least one cutting edge has two cutting edge segments that are arranged equidistant to the crossing point both when the cutting insert is received or inserted in the first cutting a insert receptacle and when the cutting insert is received or inserted in the second cutting insert receptacle.

The two cutting edge segments can, as already mentioned, be separate from one another or merge directly into one another. They can be designed as separate cutting edges or as parts of one and the same cutting edge.

“Equidistant” means that the two cutting edge segments have the same distance to the crossing point. Thus, the two cutting edge segments can be used equivalently. One cutting edge segment is used to machine the workpiece when the cutting insert is inserted into the first cutting insert receptacle. The other cutting edge segment is used when the cutting insert is inserted in the second cutting insert receptacle. Thus, one and the same cutting portion or cutting edge can be used virtually twice, which also doubles the service life.

In particular, the first cutting edge segment is in a machining position when the cutting insert is received in the first cutting insert receptacle. After reclamping or when the cutting insert is received in the second cutting insert receptacle, the second cutting edge segment is in the machining position, thus, in particular, it assumes exactly the position previously occupied by the first cutting edge segment. In other words, when the cutting insert is received in the second cutting insert receptacle, the second cutting edge segment is in the same position as the first cutting edge segment when the cutting insert is received in the first cutting insert receptacle.

Preferably, the two cutting edge segments each extend over at least 10% of a total length of the at least one cutting edge.

The two cutting edge segments are therefore preferably not just individual points on the cutting edge or very short parts of the cutting edge, but substantial portions/segments of the cutting edge that are also visible to the naked eye.

According to one embodiment, the two cutting edge segments are each designed in a straight line. In this case, the two cutting edge segments are preferably aligned transversely, i.e. not parallel, to each other.

According to an alternative embodiment, the two cutting edge segments are designed as curved cutting edge segments. For example, the two cutting edge segments are arcuate in shape. In this case, the two cutting edge segments can also merge directly into one another, i.e. be directly connected to one another. However, it is also possible for the two arcuate cutting edge segments to be separated from one another, so that a straight or differently shaped segment of the cutting portion or cutting edge is arranged between them, for example.

The cutting edge can be partially polygonal, elliptical or circular arc-shaped. For example, the cutting edge has the shape of a half trapezoid, half ellipse, or half circle. However, the cutting edge segments may have any other shape and may, for example, have parts of a parabolic shape. Likewise, the cutting edge may be shaped as a free form. Preferably, the at least one cutting edge is designed symmetrically to the longitudinal axis of the cutting insert.

In a particularly preferred embodiment, the two cutting edge segments lie on a circular arc whose center coincides with the crossing point both when the cutting insert is received in the first cutting insert receptacle and when the cutting insert is received in the second cutting insert receptacle.

In this case, the circular arc-shaped cutting edge is repositioned around the center of its circular arc when the cutting insert is reclamped from one cutting insert receptacle to the other. In this way, the two cutting edge segments that form parts of the circular arc can be used equivalently to each other in an optimal manner. In order to prevent a change in the machining properties when the cutting insert is repositioned, it is then only necessary to ensure that the tip height of the cutting edge is the same in both clamping positions of the cutting insert.

As already mentioned, the cutting portion of the cutting insert, on which the at least one cutting edge is formed, is preferably made of diamond. Due to the high cost of such a diamond, the possibility of reclamping the cutting insert according to the invention and the associated double use of the cutting insert is of particular advantage in this case.

According to a further embodiment, the cutting insert holder comprises a fastener/fixing means adapted to clamp the cutting insert in the cutting insert holder both when the cutting insert is received in the first cutting insert receptacle and when the cutting insert is received in the second cutting insert receptacle.

Thus, one and the same fixing means can be used to fix the cutting insert in both cutting insert receptacles. This is advantageous in terms of the total number of tool components and also enables the cutting insert to be reclamped quickly.

Here, it is particularly preferred that the fixing means comprises a screw that can be screwed into a thread provided in the cutting insert holder, which thread is preferably arranged equidistant to the first cutting insert receptacle and the second cutting insert receptacle.

The type of fixing/clamping of the cutting insert therefore does not change when it is repositioned/reclamped from one cutting insert receptacle to the other.

In order to enable the above-mentioned properties of equivalent and/or defined clamping of the cutting a insert in the two cutting insert receptacles, it is preferable that the first cutting insert receptacle has a first receptacle depth measured along the first center axis, and the second cutting insert receptacle has a second receptacle depth measured along the second center axis. In this context, the receptacle depth is preferably understood to be the longitudinal extension of the respective cutting insert receptacle starting from the front side of the cutting insert holder, in particular up to a stop surface for the cutting insert formed by the cutting insert holder.

The cutting insert can thus preferably be inserted into the cutting insert receptacle only over the length of the receptacle depth, wherein particularly preferably a stop for the cutting insert is formed in the respective cutting insert receptacle. This enables defined positioning of the cutting insert, in particular of the cutting edge. In particular, the receptacle depth or the stop limits how far the cutting insert can be received in the cutting insert receptacle and/or defines the distance of the cutting edge from the front side.

Preferably, a distance of the imaginary crossing point from the front side of the cutting insert holder is smaller than the first and the second receptacle depth. However, it is also possible to make the first and/or second receptacle depth shorter than the distance of the imaginary crossing point from the front side of the cutting insert holder.

The two receptacle depths are preferably of equal size.

Although two cutting insert receptacles are mentioned here, the tool according to the invention is not limited to this. In principle, it would also be possible to provide more than two cutting insert receptacles on the cutting insert holder. For example, in an embodiment with three cutting insert receptacles, the cutting insert could be used in three different positions. For example, three cutting edge segments of the cutting edge of the cutting insert would then be used in time succession to machine the workpiece. Accordingly, the present disclosure is to be understood such that the cutting insert holder has at least two cutting insert receptacles while center axes are oriented obliquely with respect to each other.

Another aspect of the present invention relates to a cutting insert for a tool for machining, in particular (shape) cutting, a workpiece. The cutting insert has a cutting portion, in particular of diamond, with a cutting edge for machining the workpiece and a rodshaped insertion portion/clamping portion for inserting/clamping in a cutting insert holder. Due to the rod shape, the cutting insert can be inserted or introduced, in particular plugged/pushed, into a corresponding cutting insert holder particularly easily. In addition, stable and secure clamping along the length of the clamping portion is made possible.

Particularly preferably, the clamping portion is designed as a prism and/or has a nonround, in particular polygonal, cross-section or a non-round, in particular polygonal, outer contour. This enables particularly secure and stable clamping in a defined position. In particular, self-centering can also be realized in this way, so that the cutting insert automatically assumes a defined position during and/or as a result of the clamping.

A further aspect of the present invention relates to an apparatus and/or linear drive, in particular a fast tool drive, for machining a preferably optical workpiece with the tool according to the invention. Corresponding advantages can be achieved hereby.

A further aspect of the present invention relates to the use of a tool according to the invention for machining optical workpieces, in particular lenses or ophthalmic/spectacle lenses, particularly preferably in or with a linear drive or fast tool drive.

It is understood that the foregoing aspects and features, and those to be explained below, may be used not only in the combination indicated in each case, but also in other combinations or alone, without departing from the scope of the present disclosure.

### BRIEF DESCRIPTION OF THE DRAWINGS:

Exemplary embodiment of the invention are shown in the drawings and are explained in more detail with reference to the following description. It shows:

FIG. 1 a perspective view of a first exemplary embodiment of the tool according to the invention in a first configuration;

FIG. 2 a perspective view of the first exemplary embodiment of the tool according to the invention in a second configuration;

FIG. 3 a perspective view from behind of the tool shown in FIG. 2;

FIG. 4 a top view from above of the tool shown in FIG. 1;

FIG. 5 a top view from above of the tool shown in FIG. 2;

FIG. 6 a principle illustration in a top view from above to illustrate a principle of the tool according to the invention;

FIG. 7 the longitudinal sectional view of the tool according to the invention indicated in FIG. 4;

FIG. 8 the cross-sectional view of the tool according to the invention indicated in FIG. 5;

FIG. 9 a perspective view of a second exemplary embodiment of the tool according to the invention;

FIG. 10 a top view from above of a third exemplary embodiment of the tool according to the invention;

FIG. 11 a principle illustration to illustrate a principle of the third exemplary embodiment of the tool according to the invention;

FIG. 12 an illustration of a fourth exemplary embodiment of the tool according to the invention; and

FIG. 13 a schematic illustration of an apparatus for machining a workpiece with the tool according to the invention.

### DETAILED DESCRIPTION:

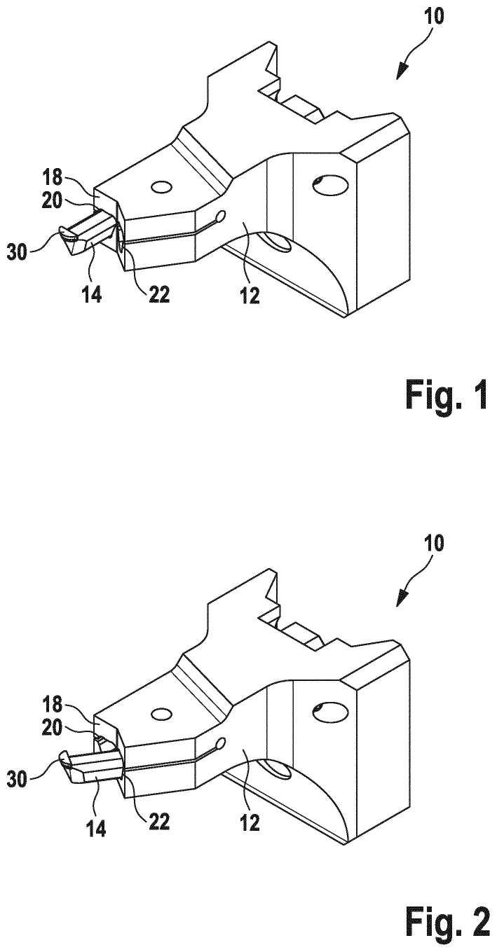

FIGS. 1-8 show a first exemplary embodiment of the tool according to the invention in various views. The tool is marked in its entirety with the reference number 10.

The tool 10 has a cutting insert holder 12 and a cutting insert 14 attached/fixed/fastened to the cutting insert holder 12.

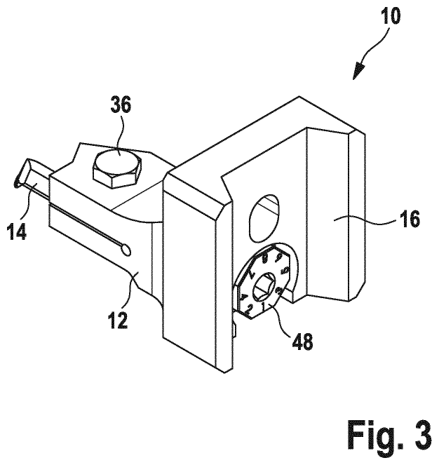

In the present exemplary embodiment, the cutting insert holder 12 is designed as a receiving cassette and/or has a (tooling) machine interface 16 on its rear side (see FIG. 3), with which it can be mounted on a (tooling) machine, in particular a linear drive and/or fast tool drive. However, the present invention is by no means limited to such a shape and configuration of the cutting insert holder 12. The latter may have any other shape. For example, it is possible for the cutting insert holder to be beam-shaped, similar to what is often the case for conventional turning tools.

Particularly preferably, the cutting insert holder 12 is made of metal, in particular stainless steel, and/or is integrally formed or shaped.

At its front face/front side 18, the cutting insert holder 12 has two cutting insert receptacles 20, 22. These are referred to herein as the first cutting insert receptacle 20 and the second cutting insert receptacle 22. The two cutting insert receptacles 20, 22 are oriented obliquely or at an angle to each other, preferably at an acute angle.

In particular, the front side 18 is to be understood as the side of the cutting insert holder 12 facing a workpiece and/or facing away from the machine interface 16 during machining. In the mounted state, when the tool 10 and/or the cutting insert holder 12 is used and/or mounted in/on an apparatus and/or a drive, the front side 18 preferably extends substantially vertically.

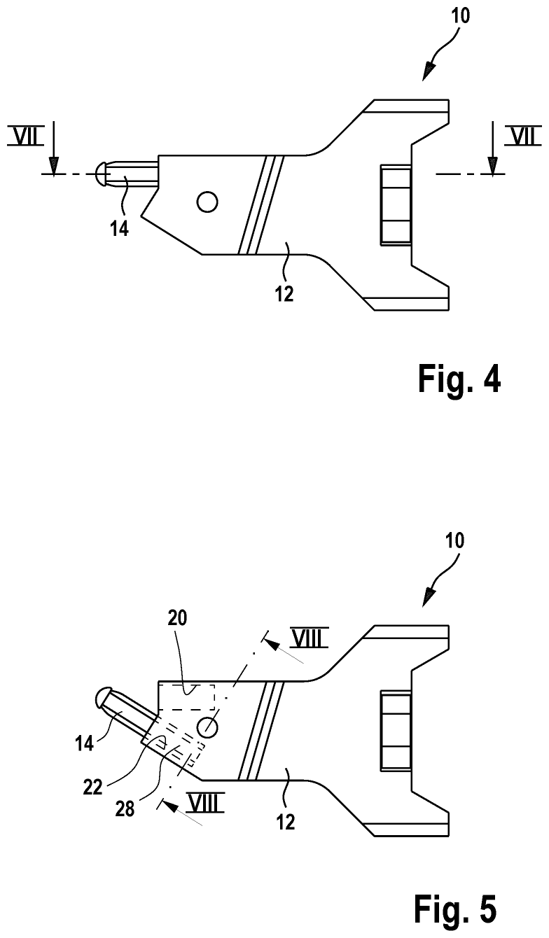

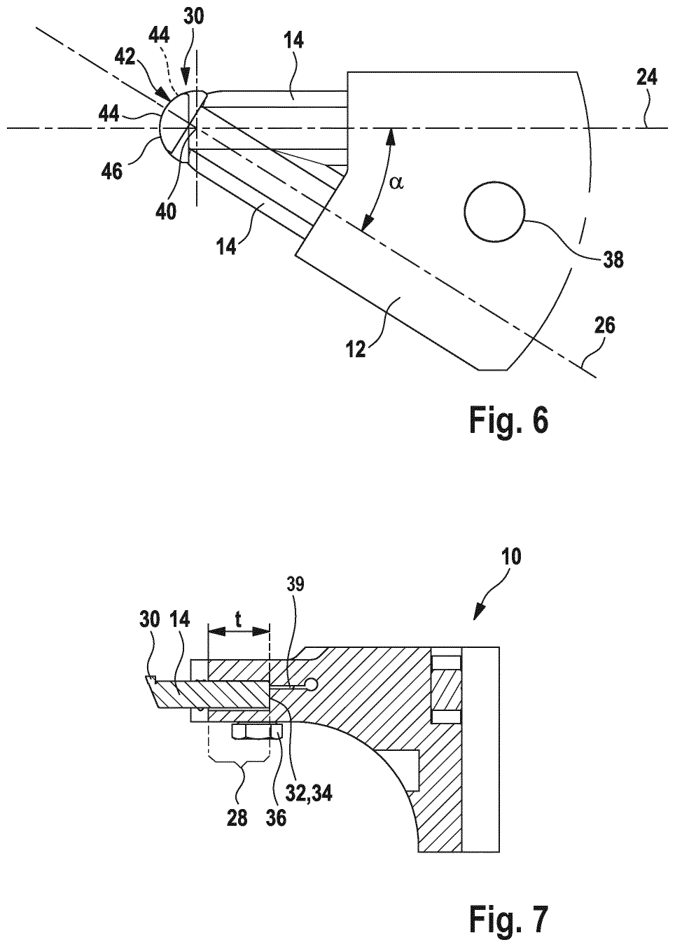

The cutting insert 14 can selectively be inserted into the first cutting insert receptacle 20 or into the second cutting insert receptacle 22. In the configuration shown in FIGS. 1 and 4, the cutting insert 14 is inserted into the first cutting insert receptacle 20. In the second configuration shown in FIGS. 2 and 5, the cutting insert 14 is inserted into the second cutting insert receptacle 22. FIG. 6 shows a principle representation that does not correspond to any configuration that can actually be implemented. In FIG. 6, a cutting insert 14 is inserted in each of the first and second cutting insert receptacles 20, 22, with partial regions of the cutting inserts 14 shown overlapping.

Simultaneous insertion of two cutting inserts into the two cutting insert receptacles 20, 22 is not intended. Due to the given arrangement and the space conditions, this is also not possible at all, in particular as can be seen from FIG. 6 due to the overlapping partial regions. Instead, in practice, the cutting insert 14 is first inserted into the first or second cutting insert receptacle 20, 22 and then inserted into the respective other cutting insert receptacle 20, 22 in a further processing step.

The cutting insert receptacles 20, 22 are preferably identical in design. This means that their shape and size are identical. They differ from each other only in their position and orientation. This can be seen in particular from FIG. 5, in which the position of the cutting insert receptacles 20, 22, which should actually not be visible in this illustration, is shown as dashed lines.

The first cutting insert receptacle 20 extends along a first center axis 24, which is shown dashed in FIG. 6. The second cutting insert receptacle 22 extends along a second center axis 26, which is also shown dashed in FIG. 6. The acute angle at which the two center axes 24, 26 are aligned with respect to each other is designated as angle α in FIG. 6.

The cutting insert receptacles 20, 22 are preferably formed as elongated clearances, recesses or depressions in the cutting insert holder 12.

The cutting insert receptacles 20, 22 preferably extend from the front side 18 into the cutting insert holder 12, in particular at least substantially orthogonally to the front side 18 and/or at least substantially horizontally in the mounted state of the tool 10 or cutting insert holder 12.

Preferably, the cutting insert receptacles 20, 22 are spaced apart from each other over their entire length and/or already at the front side 18. However, solutions are also possible in which the cutting insert receptacles 20, 22 partially overlap or intersect, in particular at the front side 18. In any case, however, the cutting insert receptacles 20, 22 are spaced apart at their ends opposite the front side 18.

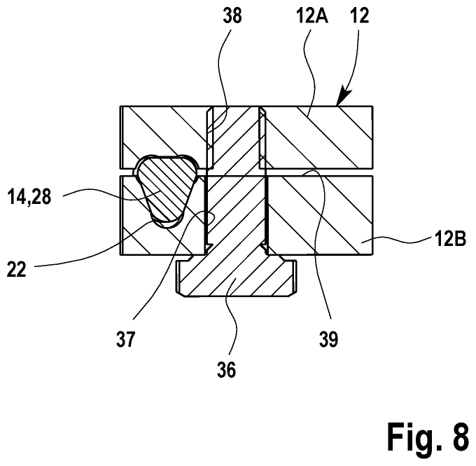

Preferably, the cutting insert receptacles 20, 22 each have a non-round or non-circular inner contour and/or a non-round or non-circular cross-section orthogonal to their longitudinal extension and/or orthogonal to the respective center axis 24, 26, as shown in particular in FIG. 8. FIG. 8 shows a cross-section perpendicular to the center axis 26. In particular, the inner surface formed by (each of) the cutting insert receptacles 20, 22 is not circular-cylindrical in shape.

The cross-section is preferably constant or uniform over the entire length of the cutting insert receptacles 20, 22.

Particularly preferably, the cross-section is polygonal, triangular in the example shown, and/or the cutting insert receptacles 20, 22 are each formed by a prismatic clearance, recess or depression.

A non-round or polygonal inner contour or a non-round or polygonal cross-section is preferably understood to mean a shape which has straight sides but which can be rounded at the corners or where the sides meet. In the example shown in FIG. 8 with a triangular contour or triangular cross-section, the three corners are rounded accordingly. However, curved sides are also possible.

A prismatic clearance, recess or depression is preferably correspondingly a clearance, recess or depression with a polygonal base surface, in which the edges and/or corners can be rounded. The side surfaces are preferably flat, but may also have a curvature.

The cutting insert 14 has a preferably substantially beam-shaped or rod-shaped insertion portion/mounting portion/clamping portion 28 and a cutting portion 30 arranged at the front end of the cutting insert 14.

The clamping portion 28 is preferably made of hard metal or (cemented) carbide.

Preferably, the clamping portion 28 is adapted to the cross-sectional shape of the cutting insert receptacles 20, 22.

Preferably, the clamping portion 28 has a non-round or non-circular outer contour and/or a non-round or non-circular cross-section orthogonal to its longitudinal extension, as shown in particular in FIG. 8. In particular, the clamping portion 28 is not circular-cylindrical in shape. Particularly preferably, the cross-section is polygonal, triangular in the example shown, and/or the clamping portion 28 is formed at least substantially as a prism.

With regard to the terms “non-round”, “polygonal” and “prism”, the same explanations as for the cutting insert receptacles 20, 22 preferably apply. In particular, the edges and/or corners of the clamping portion 28 may be rounded and/or its side surfaces may be curved.

The part or portion of the cutting insert 14 projecting from the front side 18 in the clamped state can be designed differently from the clamping portion 28 located in the cutting insert receptacle 20, 22, but is preferably of the same design. Particularly preferably, the cutting insert 14 consists only of a rod-shaped, bar-shaped or beam-shaped, preferably prismatic, portion, in particular of hard metal or (cemented) carbide, and the cutting portion 30, in particular of diamond or coated with diamond.

The cutting insert 14 is preferably formed as one piece, in particular wherein the cutting portion 30 is produced by brazing the cutting insert 14 with diamond. Alternatively, coating with diamond is also possible. Solutions are also possible in which the cutting portion 30 is made of (ground or sharpened) hard metal or (cemented) carbide. Particularly preferably, the cutting insert receptacles 20, 22, as shown in FIGS. 1-8, are designed/constructed as receptacle pockets so that the cutting insert 14 can be inserted into the respective cutting insert receptacle 20, 22 from the front side 18. Particularly preferably, introduction or insertion is only possible in a certain orientation, in particular due to an asymmetrical cross-section of clamping portion 28 and the respective cutting insert receptacle 20, 22.

In the example shown in FIG. 8, the respective cross sections are, for example, isosceles triangles, in particular with rounded corners, the bases of which have a different, in particular shorter, length than the legs. In particular, the cross sections are thus not equilateral. In this way, in particular, incorrect positioning of the cutting insert 14 can be avoided.

However, solutions are also possible in which the cutting insert 14 can be inserted in different orientations into the respective cutting insert receptacles 20, 22 and/or in which the respective cross sections are symmetrical, in particular equilateral. This can be advantageous if a different cutting portion or a different part of the cutting portion 30 can be used as a result. In addition to reclamping/changing from one cutting insert receptacle 20, 22 to another cutting insert receptacle 22, 20, a different cutting portion or cutting edge segment can thus be selected by changing the orientation of the cutting insert 14, in particular by rotating it about its longitudinal axis.

Each cutting insert receptacle 20, 22 preferably has a rear stop surface/rear locating surface 32 (see FIG. 7). The cutting insert 14 and/or clamping portion 28 preferably has a corresponding (counter/mating) contact/abutment surface 34, which abuts against the stop surface 32 in the mounted state. In particular, during mounting, the cutting insert 14 is inserted, in particular introduced or pushed or slid, into the respective cutting insert receptacle 20, 22 until the (counter/mating) abutment surface 34 abuts against the stop surface 32. In this way, a defined positioning of the cutting portion 30, in particular a defined distance of the cutting portion 30 from the front side 18, is preferably achieved.

Solutions are also possible in which the front side 18 forms a stop instead. In this case, a collar or the like on the cutting insert 14 preferably forms a corresponding counter stop, so that the cutting insert 14 can only be inserted up to this counter stop.

A depth t of the cutting insert receptacles 20, 22 measured from the front side 18 of the cutting insert holder 12 to its rear stop surface 32, also referred to herein as the receptacle depth t, is preferably the same for both cutting insert receptacles 20, 22. This is particularly advantageous in the case of a cutting portion 30 with a circular cutting edge 42, as shown here and explained in more detail below, since the same distance between the cutting edge 42 and the front side 18 can thus be ensured, irrespective of the cutting insert receptacle 20, 22 in which the cutting insert 14 is received.

However, solutions are also possible in which the receptacle depths t of the cutting insert receptacles 20, 22 are different. This is particularly conceivable for cases in which the cutting portion 30 or its cutting edge 42 is asymmetrically designed, for example due to limitations imposed by the manufacture or geometry of the cutting portion 30. With the same insertion depth in the cutting insert receptacles 20, 22, such asymmetry can lead to different distances of the cutting edge 42 from the front side 18. Different receptacle depths t can preferably compensate for the asymmetry or ensure that the distance from the front side 18 to the asymmetrical cutting edge 42 or cutting portion 30 is the same for all cutting insert receptacles 20, 22.

The cutting insert 14 is clamped or fixed in the respective cutting insert receptacle 20, 22 preferably by means of a fastener/fastening means/fixing means 36, in particular a screw, which engages in a receptacle, in particular a thread 38, provided in the cutting insert holder 12.

Preferably, (exactly) one or the same fixing means 36 or screw is used for clamping/fixing the cutting insert 14 in both cutting insert receptacles 20, 22.

Particularly preferably, only one receptacle or only one thread 38 is provided for the fixing means 36 or the screw. It is therefore preferably intended to use the same fixing means 36 in the same position or receptacle to fix, in particular clamp, the cutting insert 14 in both the first cutting insert receptacle 20 and the second cutting insert receptacle 22.

The fixing means 36/screw or receptacle/thread 38 is preferably positioned to clamp the cutting insert 14 or its clamping portion 28 equally or with equal force in the first cutting insert receptacle 20 as well as the second cutting insert receptacle 22.

The exact positioning of the fixing means 36/screw and/or receptacle/thread 38 so that uniform/equal clamping is achieved depends on the geometry of the cutting insert holder 12 and can be determined, for example, using FEM simulation.

In the case of a completely symmetrical cutting insert holder 12, the fixing means 36/screw or the receptacle/thread 38 can be arranged centrally between and/or equidistant from the two center axes 24, 26. Since the cutting insert holder 12 is asymmetrically designed in the area of the front side 18 in the example shown, the arrangement there is slightly offset in the direction of the first center axis 24.

Preferably, the cutting insert 14 can be reclamped/repositioned or changed by loosening the fixing means 36 or screw, but without completely removing the fixing means 36 or completely unscrewing the screw from the thread 38. This enables a particularly simple change.

Particularly preferably, self-centering of the cutting insert 14 takes place when it is fixed in the respective cutting insert receptacle 20, 22. This is preferably understood to mean that the cutting insert 14, during fixing/clamping, automatically or self-actingly assumes a defined position in the cutting insert receptacle 20, 22 and/or relative to the respective center axis 24, 26 and/or to the cutting insert holder 12. Preferably, the self-centering takes place orthogonally to the respective center axis 24, 26, while the defined positioning in the direction of the center axis 24, 26 takes place by the stop surface 32 and (mating/counter) abutment surface 34, as explained above.

In the following, a particularly preferred embodiment of the fastening/fixing of the cutting insert 14 is explained in more detail with reference to FIG. 8.

The cutting insert holder 12 preferably has a first section/portion 12A and a second section/portion 12B. The portions 12A, 12B are preferably each formed in a plate-like manner. However, as explained further above, the cutting insert holder 12 is preferably integrally formed (as one piece), so in particular the portions 12A, 12B are also integrally formed (as one piece) with the cutting insert holder 12.

The first portion 12A and the second portion 12B are preferably separated from each other by a slot or gap 39. The gap 39 preferably extends from the front side 18, in particular orthogonally to the front side 18 and/or at least substantially horizontally in the mounted state of the cutting insert holder 12.

The gap 39 preferably extends through the cutting insert receptacles 20, 22 and/or divides them into two sections/portions. Particularly preferably, the gap 39 extends beyond the cutting insert receptacles 20, 22, as can be seen in particular in FIG. 7.

The gap 39 preferably extends off-center through the cutting insert holder 12 and/or the portions 12A, 12B are preferably of different thicknesses and/or have different extensions parallel to the front side 18, as shown in FIG. 8.

Preferably, the first portion 12A has the thread 38 and/or the second portion 12B has an opening/aperture or bore 37. The screw is preferably passed through the second portion 12B, in particular the aperture 37, and screwed into the first portion 12A, in particular its thread 38.

Preferably, by screwing in or tightening the screw, the first portion 12A is drawn towards the second portion 12B and/or the width of the gap 39 is reduced. This fixes, in particular clamps, the cutting insert 14, in particular its clamping portion 28, in the respective cutting insert receptacle 20, 22 and/or between the first and second portions 12A, 12B.

Particularly preferably, in this case, only the first portion 12A moves and/or the first portion 12A is braced/biased/tensioned against the second portion 12B and/or the clamping portion 28. This can be achieved in particular by a smaller plate thickness of the first portion 12A compared to the second portion 12B. This is conducive to a defined positioning of the cutting insert 14.

The self-centering of the cutting insert 14 is preferably realized by the cross-section of the cutting insert 14 and/or the corresponding cross-section of the respective cutting insert receptacle 20, 22, in particular by a respective polygonal cross-section as previously described.

In the example shown in FIG. 8, the cross-section of the cutting insert 14 has a triangular shape and/or a wedge shape. This shape preferably ensures that the cutting insert 14 is automatically or self-actuated fixed/clamped in the intended, defined position. Other cross-sectional shapes are also conceivable here.

The clamping portion 28 does not have to lie/abut completely against the inner surface of the respective cutting insert receptacle 20, 22. In the example shown in FIG. 8, only the (flat) side surfaces abut there, while the (rounded) edges do not.

Preferably, the cutting insert 14 is only in a pivoted position after repositioning from one cutting insert receptacle to the other, but does not undergo any translational displacement. The positions obtained by the repositioning correspond to a pivoting by an angle α around an imaginary crossing point or imaginary intersection point 40, which can be seen in particular in FIG. 6. The imaginary crossing point 40 is the geometric crossing point of the two center axes 24, 26. This crossing point 40 is located in an area that is covered by the cutting insert 14 both when the cutting insert 14 is inserted in the first cutting insert receptacle 20 and when the cutting insert 14 is inserted in the second cutting insert receptacle 22. In FIG. 6, this is schematically illustrated by the fact that the cutting insert 14 is shown in one and the same illustration both in its position inserted into the first cutting insert receptacle 20 and in its position inserted into the second cutting insert receptacle 22.

In the usual position of use and/or when the tool 10 and/or the cutting insert holder 12 is attached/mounted to a corresponding apparatus or machine, the plane in which the two cutting insert receptacles 20, 22 are located is preferably at least substantially horizontal. Thus, after reclamping or repositioning, the cutting insert 14 is preferably at the same height and/or in the same horizontal plane as before. In particular, the repositioning results in a pivoted position of the cutting insert 14 in the horizontal plane.

The cutting portion 30, which is preferably made of diamond, has an arcuate/bent/curved/arc-shaped cutting edge 42 in the first exemplary embodiment shown in FIGS. 1-8. In the example shown here, the cutting edge 42 is circular arc-shaped. The center of this circular arc coincides with the crossing point 40. Thus, by reclamping the cutting insert 14 from one cutting insert receptacle 20 to the other cutting insert receptacle 22 or vice versa, the cutting edge 42 is in result merely pivoted about the crossing point 40, so that the individual sections/portions of the cutting edge 42 remain on one and the same circular arc.

If one now regards a part of the circular arc-shaped cutting edge 42 as the first cutting edge portion/segment 44 and an adjacent part of the cutting edge 42 as the second cutting edge portion/segment 46, these two cutting edge segments 44, 46 can be used in an equivalent manner. The first cutting edge segment 44 can be used when the cutting insert 14 is fixed/clamped in the first cutting insert receptacle 20. This use position or machining position of the first cutting edge segment 44 is indicated with a solid line in FIG. 6. The second cutting edge segment 46 can be used when the cutting insert 14 is fixed/clamped in the second cutting insert receptacle 22. Then, the second cutting edge segment 46 moves to the use position or machining position where the first cutting edge segment 44 was previously located. The first cutting edge segment 44 moves out of the use position or machining position, which is indicated with a dashed line in FIG. 6. The use position or machining position is preferably located between the center axes 24, 26. The two cutting edge segments 44, 46 can be any portions of the cutting edge 42, which are arranged adjacent to each other or even merge into each other.

It is thus possible to use different portions/parts of the cutting edge 42 for machining the workpiece, depending on the fixation/mounting/clamping of the cutting insert 14. As a result, one and the same cutting portion 30 can be used twice. Here, the two cutting edge segments 44, 46 are preferably equidistant to the crossing point 40 and preferably symmetrical to the longitudinal axis of the cutting insert 14.

In the illustrated example, the cutting insert holder 12 has a height adjustment device 48. In the exemplary embodiment shown here, the height adjustment device 48 is accessible from the rear side of the cutting insert holder 12 (see in particular FIG. 3), although other solutions are also possible here.

By means of the height adjustment device 48, the height of the tool 10 and/or of the cutting insert holder 12 can preferably be adjusted, in particular set or positioned, relative to the machine to which the cutting insert holder 12 is or will be mounted.

In this context, “height adjustment” is preferably understood to mean an at least essentially vertical alignment, although the adjustment can also take place-depending on the machine-in another spatial direction. An adjustability in multiple spatial directions, for example by providing multiple adjustment devices, is also conceivable. The “tip height” is preferably to be understood as the height or vertical position of the cutting edge 42.

By means of the height adjustment device 48, in particular, an adjustment or setting of the tip height of the cutting edge 42 can be carried out.

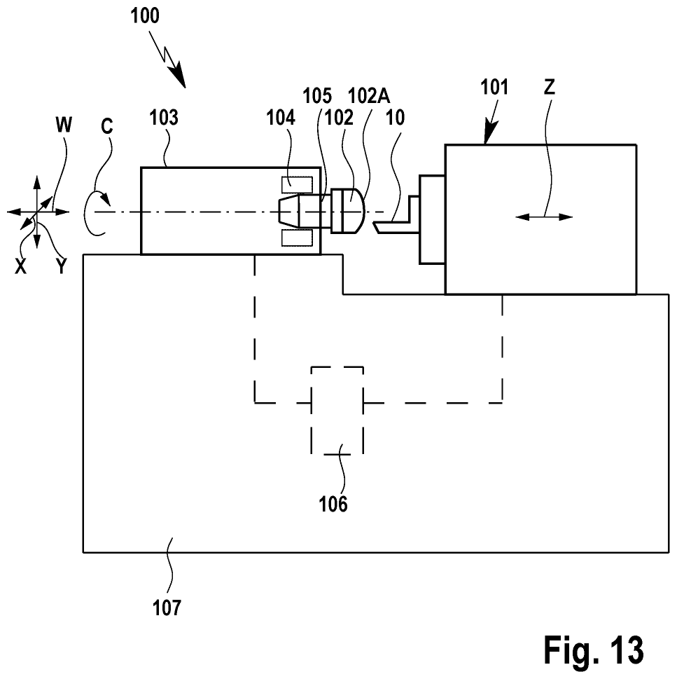

The adjustment carried out by means of the height adjustment device 48 serves here preferably only a rough/coarse pre-adjustment. By way of example, it is explained further below with reference to FIG. 13 how a fine adjustment can be made by fine adjustment of the height of the workpiece that is or is to be machined with the tool 10.

When the cutting edge 42 is worn, it is preferably reprocessed/reconditioned, in particular reground or relapped. In this way, the cutting insert 14 can be used again, which saves costs and resources. Preferably, this is done multiple times or as often as possible, in particular more than twice or five times and/or less than ten times. However, reconditioning changes, in particular reduces, the tip height of the cutting edge 42, for example by more than 0.1 mm per reconditioning. The difference between a new cutting insert 14 and one that has been reconditioned several times can vary by up to 0.8 mm or more. The height adjustment device 48 preferably serves to at least partially compensate for the change in tip height caused by reconditioning of the cutting edge 42. This is particularly advantageous if such large height changes cannot be compensated on the workpiece side. In particular, therefore, a coarse/rough or first height adjustment, for example by 0.1 mm or more, is made by means of the height adjustment device 48, and a fine or second height adjustment, for example to an accuracy 0.01 mm or 0.001 mm, is made by adjusting the height of the workpiece.

Preferably, the tip height can be adjusted by means of the height adjustment device 48 by a total of more than 0.8 mm or 1 mm and/or less than 2.5 mm or 2 mm, particularly preferably in discrete increments of more than 0.1 mm and/or less than 0.3 mm.

In the illustrated example, the height adjustment device 48 preferably forms a stop surface for a corresponding counter stop on a carriage to which the tool 10 is attached/mounted (not shown). By actuating, in particular rotating, the height adjustment device 48, the stop surface can be displaced in height or a new stop surface can be set so that the tool 10 is adjusted in height.

In the illustrated example, the height adjustment device 48 preferably has a rotatable, polygonal disc, as shown in particular in FIG. 3. Here, the side surfaces have a different distance to the eccentrically arranged axis of rotation, with one of the side surfaces forming the stop surface. A rotation causes another side surface with a different distance from the axis of rotation to form the stop surface.

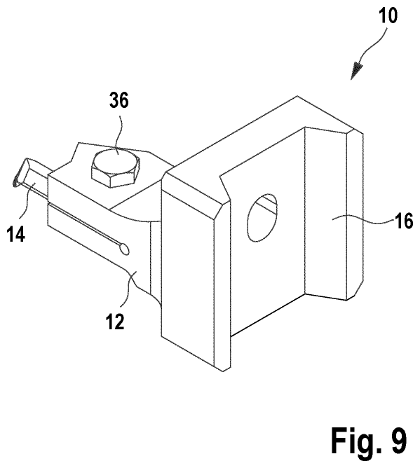

However, it is also possible to form the tool 10 and/or the cutting insert holder 12 without the height adjustment device 48. This is shown by way of example in FIG. 9. FIG. 9 shows a second exemplary embodiment of the tool 10 according to the invention in an illustration corresponding to FIG. 3. The previous features and explanations preferably apply accordingly, additionally or supplementarily, even if repetition is omitted. Preferably, the only difference between the first and second exemplary embodiments is that in the second exemplary embodiment no height adjustment device 48 is provided. The height adjustment device 48 can be dispensed with, in particular, if the tool 10 is to be used in an apparatus that can compensate for larger height differences on the workpiece side by itself. Furthermore, the height adjustment device 48 can also be dispensed with if generally no height adjustment or setting is necessary, for example if the cutting insert 14 is not reused. This may be the case, in particular, if the cutting portion 30 is made of less expensive materials.

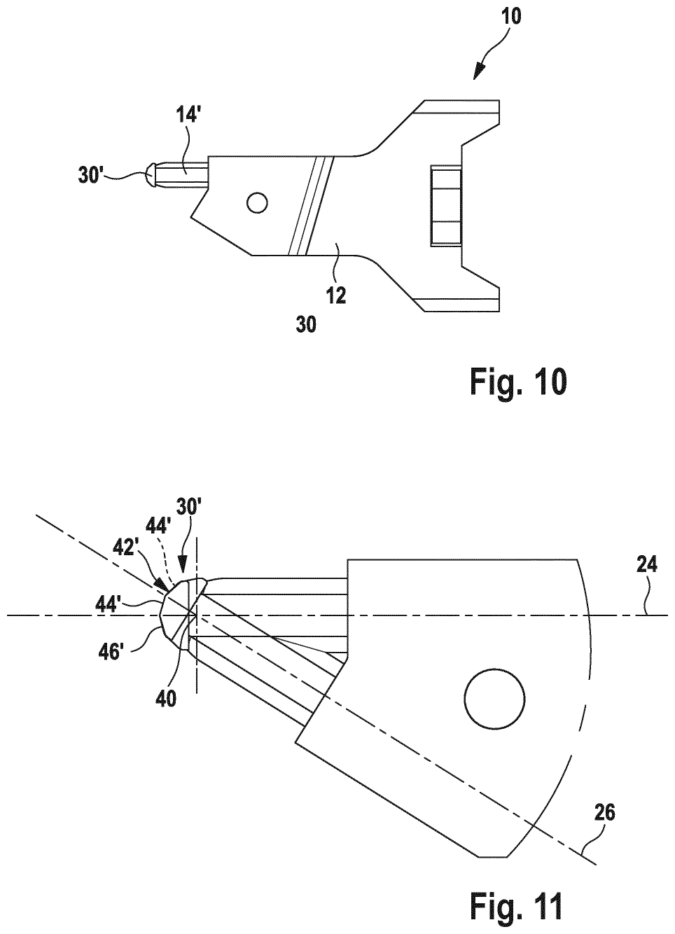

FIGS. 10 and 11 show a third exemplary embodiment of the tool 10 according to the invention. The previous features and explanations preferably apply accordingly, additionally or supplementarily, even if they are not repeated.

The cutting insert holder 12 is preferably configured the same as before, in FIGS. 10 and 11 the same as the cutting insert holder 12 according to the first exemplary embodiment. The cutting insert 14′ preferably differs from the cutting insert 14 only by a slightly different cutting portion 30′.

According to the third exemplary embodiment, the cutting portion 30′ is partially polygonal or polygonal. The cutting edge 42′ has a plurality of rectilinear/straight cutting edge segments 44′, 46′. These cutting edge segments 44′, 46′ are arranged equidistant to the crossing point 40. Thus, the cutting insert 14′ is also usable in the same manner as previously mentioned in both orientations, i.e., both when it is inserted in the first cutting insert receptacle 20 and when it is inserted in the second cutting insert receptacle 22. In FIG. 11, the positions of the first and second cutting edge segments 44′, 46′ are shown analogously to FIG. 6. In particular, the first cutting edge segment 44′ is shown both in the use position or machining position (solid line) and in a position offset therefrom (dashed line).

It is also possible that the cutting edge is oval or elliptical.

The cutting insert 14 according to the third exemplary embodiment can also be used in a cutting insert holder 12 according to the second exemplary embodiment without height adjustment device 48.

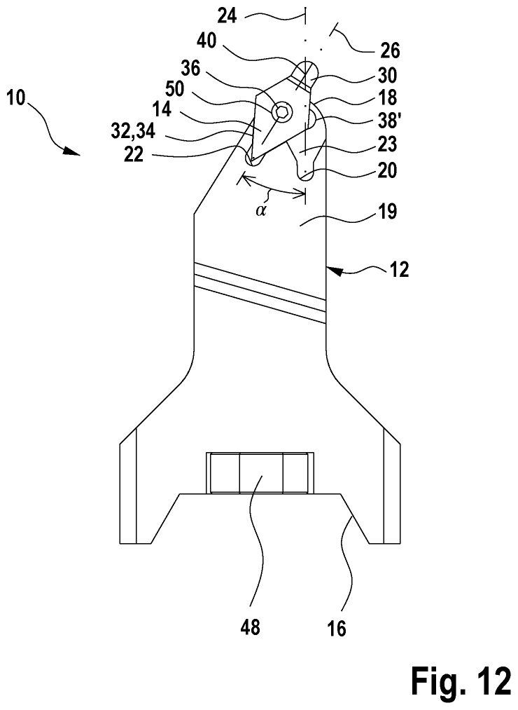

FIG. 12 shows a fourth exemplary embodiment of the tool 10 according to the proposal. In the following description, essentially only the differences from the previous exemplary embodiments are explained. The previous features and explanations preferably apply accordingly, additionally or supplementarily, even if they are not repeated. The same reference signs as before are used for identical or similar components, in particular wherein identical or similar properties, advantages and effects are also achieved. The fourth exemplary embodiment differs from the previous exemplary embodiments in the arrangement and design of the cutting insert receptacles 20, 22 and the corresponding cutting insert 14.

In the fourth exemplary embodiment, the cutting insert receptacles 20, 22 are preferably arranged or formed on an upper side or top side 19 of the tool 10 and/or the cutting insert holder 12.

The upper side 19 is here preferably a side of the tool 10 and/or of the cutting insert holder 12, which is arranged transversely, in particular orthogonally, to the front side 18. When the tool 10 and/or the cutting insert holder 12 is used and/or mounted in/to an apparatus or a drive, the upper side 19 preferably runs substantially horizontally.

Particularly preferably, the upper side 19 is the side that is oriented upward or accessible from above when the tool 10 and/or the cutting insert holder 12 is in the mounted state. However, other solutions are also possible here.

In the fourth exemplary embodiment, the cutting insert receptacles 20, 22 are preferably formed as clearances, recesses or depressions on the upper side 19. In particular, the clearances, recesses or depressions extend from the front side 18 or the edge between the front side 18 and the upper side 19 along their respective center axes 24, 26.

Preferably, the cutting insert receptacles 20, 22 are at least substantially V-shaped and/or taper from the front side 18 or the edge between the front side 18 and the upper side 19 in the direction of their respective center axis 24 or 26.

In the example shown, the cutting insert receptacles 20, 22 are rounded at their tapered or rear end. However, other solutions are also possible here.

Also in this exemplary embodiment, the receptacle depth is preferably understood to be the extension of the respective cutting insert receptacle 20, 22, in particular of the clearance, recess or depression which forms the respective cutting insert receptacle 20, 22, starting from the front side 18, here in particular along the upper side 19. In particular, also here the receptacle depth limits how far the cutting insert 14 can be received in the cutting insert receptacle 20, 22 and/or defines the distance of the cutting portion 30 or cutting edge 42 from the front side 18.

With regard to the alignment and/or arrangement of the cutting insert receptacles 20, 22 relative to one another, the same explanations as before preferably apply. In particular, the cutting insert receptacles 20, 22 are inclined to each other in such a way that their center axes 24, 26 intersect at an imaginary crossing point 40, for which preferably the same explanations as before apply. The (acute) angle α, by which the center axes 24, 26 are inclined to each other, is shown in FIG. 12.

Preferably, the cutting insert receptacles 20, 22 form a common receptacle area/region 23 formed by a continuous recess. In other words, the cutting insert receptacles 20, 22 preferably partially overlap or intersect.

Particularly preferably, the receptacle region 23 is at least essentially W-shaped and/or the two partially overlapping, in particular V-shaped cutting insert receptacles 20, 22 form the at least essentially W-shaped receptacle region 23.

The cutting insert receptacles 20, 22 are preferably formed identically and/or mirror-symmetrically to each other. A symmetry axis or mirror axis of the cutting insert receptacles 20, 22 or of the receptacle region 23 preferably runs through the crossing point 40, in particular in such a way that it also forms a mirror axis of the center axes 24, 26.

The cutting insert 14 is preferably designed to correspond to the cutting insert receptacles 20, 22, in particular with a corresponding V-shaped portion or, at least in segments, V-shaped outer contour.

The cutting insert 14 is preferably plate-shaped or designed as a plate, in particular as a cutting plate.

Particularly preferably, the cutting insert 14 or its outer contour is at least essentially rhombic or diamond-shaped. However, other solutions are also possible here, for example the shape of a kite quadrilateral.

The cutting insert 14 is preferably a standardized component, in particular a cutting insert or indexable insert according to ISO 1832, for example ISO 1832:2017.

The cutting insert 14 preferably has at least one cutting portion 30. The cutting portion 30 is preferably formed as described for the first exemplary embodiment or as described for the second exemplary embodiment.

The cutting insert 14 may also have multiple cutting portions 30, for example at opposing edges or corners. This has the advantage that the cutting insert 14 can be turned within a cutting insert receptacle 20 or 22, so that a different cutting portion 30 can be used. The cutting portions 30 may be of the same or different design, in particular to enable the same or different machining operations.

Preferably, also in the fourth exemplary embodiment, the respective cutting insert receptacle 20, 22 forms a stop for the cutting insert 14, which limits how far the cutting insert 14 can be received in the cutting insert receptacle 20, 22 and/or allows a defined distance of the cutting portion 30 or cutting edge 42 from the front side 18.

In the illustrated example with V-shaped design of the cutting insert receptacles 20, 22, each cutting insert receptacle 20, 22 or its stop preferably has two stop surfaces 32 formed by the V-shape. The cutting insert 14 preferably has two corresponding (counter) abutment surfaces 34. Particularly preferably, the two stop surfaces 32 enclose the same angle as the two (counter) abutment surfaces 34.

Preferably, at least one receptacle, in particular a thread 38, for a fixing means 36 is provided on the cutting insert holder 12, in particular its receptacle region 23, for fastening/fixing the cutting insert 14.

In the example shown, each cutting insert receptacle 20, 22 has its own thread 38, 38′. In particular, the cutting insert holder 12 and/or receptacle region 23 has two threads 38, 38′. However, solutions are also possible in which only one (common) thread 38 is provided, which is arranged in particular between the cutting insert receptacles 20, 22 or in their overlap region/area (not shown).

The cutting insert 14 preferably has one (central) aperture or opening 50, particularly preferably only one (central) aperture or opening 50.

A fixing means 36, in particular a screw, is guided through the aperture/opening 50 of the cutting insert 14 and fastened/fixed in the corresponding receptacle, in particular screwed into the thread 38 or 38′, so that the cutting insert 14 is held on the cutting insert holder 12, in particular in a force-fitting and/or form-fitting manner.

However, other solutions are also possible here, for example, the cutting insert 14 could alternatively or additionally have a thread, or instead of a thread on the cutting insert 14 and/or cutting insert holder 12, a fastening could be made by means of a lock nut or the like.

To fasten/fix the cutting insert 14, it is preferably inserted or placed into the desired cutting insert receptacle 20, 22, in particular from above, and then fastened/fixed by means of the fixing means 36, in particular the screw, in particular from above and/or from the same side from which the cutting insert 14 was inserted/placed.

Preferably, the fastening/fixing of the cutting insert 14 is self-centering.

Preferably, for repositioning/reclamping, the fixing means 36 is loosened, in particular removed, the cutting insert 14 is removed from the cutting insert receptacle 20, 22 and inserted into the other cutting insert receptacle 22, 20. Subsequently, the cutting insert 14 is (re) fastened with the fixing means 36, especially preferably via the same aperture/opening 50 of the cutting insert 14 as before and/or via another receptacle or thread 38′ of the cutting insert holder 12 than before.

As a result of the reclamping, the cutting insert 14 is preferably in a position pivoted about the crossing point 40 by an angle α, as described previously for the other exemplary embodiments. Therefore, the same explanations and advantages as before apply here.

The tool 10 and/or the cutting insert holder 12 according to the fourth exemplary embodiment preferably comprises the height adjustment device 48, as shown in FIG. 12.

However, it is also possible here to form the tool 10 and/or the cutting insert holder 12 without the height adjustment device 48, as described in connection with the second exemplary embodiment.

In general, in particular for the first, second, third and/or fourth exemplary embodiment(s), it is also possible that the cutting insert holder 12 has not only two cutting insert receptacles 20, 22, but three or more cutting insert receptacles that are oriented obliquely to each other. In such a case, the center axes of all cutting insert receptacles intersect at the crossing point 40. Then, the cutting insert 14 can be used not only twice, thus in two different arrangements in the cutting insert holder 12, but multiple times according to the number of cutting insert receptacles.

FIG. 13 schematically shows a proposed apparatus 100 and/or a proposed linear drive 101 for processing/machining a preferably optical workpiece 102, in particular an optical surface 102A. The optical workpiece 102 is, for example, a lens or an eyeglass/spectacle lens, particularly preferably made of plastic. Preferably, machining, in particular (shape) cutting, of the workpiece 102 or its surface or flat side 102A is performed by turning, in particular by face turning.

In the illustrated and preferred exemplary embodiment, the apparatus 100 preferably has a workpiece spindle 103. The workpiece spindle 103 is in particular a preferably directly driven, precisely mounted shaft and/or a direct drive or other drive, in each case preferably with an integrated receptacle 104 for the workpiece 102. In principle, a direct receiving or fixing/clamping of the workpiece 102 can be provided, but preferably the workpiece 102 is held indirectly via a holder 105.

The workpiece 102 and/or the holder 105 can preferably be mounted/fixed/clamped in a specific axial position and/or rotational position in order to be able to machine the workpiece 102 in a defined manner. For this purpose, the holder 105 may also be constructed in multiple parts.

By means of the workpiece spindle 103, the mounted/clamped workpiece 102 can be set into rotation about a C-axis for machining. The workpiece spindle 103 thus forms, in particular, a rotary drive for the workpiece 102. The workpiece spindle 103 forms, in particular, a computed or controlled rotary axis C. Particularly preferably, the workpiece 102 can be set into rotation in a controlled or feedback-controlled manner at a specific rotational speed and/or with a defined rotational position.

Preferably, the apparatus 100 includes a control device 106 for controlling or feedback-controlling the workpiece spindle 103 and/or for controlling or feedback-controlling the linear drive 101 and/or for other control or feedback-control purposes.

The workpiece 102 is preferably machined, in particular (shape) cut, by means of the tool 10. The tool 10 is held by the linear drive 101 and is linearly movable relative to the workpiece 102 in one direction of movement by means of the linear drive 101, as indicated by the double arrow Z in FIG. 13.

Preferably, the tool 10 is attached/fixed/mounted to the linear drive 101 such that the cutting insert receptacles 20, 22 are at least substantially in a horizontal plane.

Preferably, the workpiece spindle 103 with the workpiece 102 to be machined can be advanced or positioned in a W-direction (preferably in the direction of the spindle axis and/or rotation axis C) relative to the tool 10 and/or linear drive 101 and/or can be moved or displaced in an X-direction transverse or perpendicular to the W-direction or Z-direction. Further, the workpiece 102 and/or the workpiece spindle 103 can optionally additionally be movable or displaceable in a Y-direction transverse or perpendicular to the X-direction and/or W- or Z-direction relative to the tool 10. In principle, other or additional directions and/or axes of movement are also possible.

If necessary, the axial alignment of the rotational or rotary axis C of the workpiece spindle 103 can also be oblique to the W-, X- and/or Y-direction or W-, X- and/or Y-axis.

The directions or axes W and X preferably run at least substantially horizontally. The direction or axis Y preferably runs at least essentially vertically.

Preferably, the adjustment in the Y-direction or the Y-axis serves only for a fine adjustment or height adjustment, as explained before in connection with the height adjustment device 48 of the tool 10. The height adjustment can be performed exclusively via the Y-axis or in addition to the (coarser/rougher) height adjustment by means of the height adjustment device 48.

The direction of the Z-axis on the one hand and the direction of the W-axis and/or the axial alignment of the rotary or circular axis C on the other hand can be parallel or inclined to each other and/or adjustable or inclinable to each other.

In the illustration example, the axis of movement or linear axis Z preferably runs at least essentially parallel to the axis of rotation or rotary axis C of the workpiece 102. Particularly preferably, however, the Z-axis is inclined or tiltable relative to the W-axis and/or C-axis, in particular by more than 3° or 5° and/or less than 15° or 10°, especially preferably by about 7°. This has the advantage that the above-mentioned fine adjustment in the Y-direction can be made by shifting the zero point.

If the Z-axis is inclined to the W-axis and/or C-axis, the tool 10 and/or the cutting insert holder 12 is preferably attached to the linear drive 101 in such a way that this inclination is compensated again, in particular so that the cutting portion 30 and/or the center axes 24, 26 are horizontal and/or oriented orthogonally to the flat side 102A of the workpiece 102.

Preferably, the W-axis is used for basic infeed of the workpiece 102 and tool 10, particularly over longer travel or infeed distances/paths.

Preferably, the linear drive 101 is an electrically operating axle drive, in particular a so-called fast tool drive, in order to control and/or quickly/rapidly move the tool 10 back and forth in its axial position or Z-axis, in particular as a function of the rotational position of the workpiece 102 and/or as a function of the distance of the tool 10 from the rotational axis of the workpiece spindle 103. The linear drive 101 permits a preferably linear and/or controlled or feedback-controlled movement of the tool 10, and therefore preferably forms a controlled or feedback-controlled linear axis Z.

In contrast to the W-axis, the linear axis Z forms a preferably highly dynamic and/or fast axis or movement, in particular as a function of the rotational position of the workpiece and/or the workpiece spindle 103. The linear drive 101 thus serves in particular for a very fast/rapid movement of the tool 10 in the Z-direction as a function of the rotational position of the workpiece, preferably however with a relatively small stroke.

The maximum stroke or travel path of the linear drive 101 and/or tool 10 is preferably several millimeters, in particular more than 10 mm or 12 mm, especially preferably about 15 mm, in particular at movement frequencies of more than 25 or 50 Hz and/or at accelerations of more than 50 m/s², or 100 m/s², especially preferably of about 300 m/s² or up to 400 m/s². The tool 10 may also be moved back and forth multiple times in the Z-direction during one revolution of the workpiece 102.

The linear drive 101 may be configured, for example, as shown in WO 2013/117327 A2, the contents of which are hereby incorporated in this application.

During machining, the workpiece 102 is preferably moved relative to the tool 10 in the X-direction and/or Y-direction to provide the desired surface machining, particularly of a surface and/or the flat side 102A.

The apparatus 100 preferably has a housing, frame or machine bed 107 that supports the workpiece spindle 103 and the linear drive 101. The workpiece spindle 103 and the linear drive 101 are preferably movably mounted or arranged on the machine bed 107 via slides or the like (not shown).

Particularly preferably, the tool 10 and/or the cutting insert holder 12 is attached/mounted or attachable/mountable in the apparatus 100 and/or to the linear drive 101 in such a way that the cutting insert 14 can be repositioned/reclamped or replaced without detaching/demounting the cutting insert holder 12.

To reposition/reclamp or change the cutting insert 14, it is preferably only necessary to loosen the fixing means 36 and remove the cutting insert 14 from the corresponding cutting insert receptacle 20, 22. Then the cutting insert 14 or a new cutting insert 14 is inserted into the other cutting insert receptacle 22, 20 and fixed again by means of the fixing means 36. Loosening of the cutting insert holder 12 is preferably not necessary.

In particular, the fixing means 36 is accessible or releasable without removing/demounting the cutting insert holder 12 and/or with mounted cutting insert holder 12, in particular from above.

When using a new cutting insert 14 or a reconditioned, in particular relapped, cutting insert 14, a readjustment or realignment may be necessary, in particular by means of the W-, X- and/or Y-axis of the workpiece spindle 103. In particular, thus, the position of the workpiece 102 is adapted to the new or reconditioned cutting insert 14.

Particularly preferably, the tool 10 and/or the cutting insert holder 12 is designed/constructed in such a way that no readjustment or realignment is necessary when the same cutting insert 14 is reclamped, thus when changing from one cutting insert receptacle 20, 22 to another cutting insert receptacle 22, 20. Preferably, the positioning is performed exclusively by the above-described design/construction of the tool 10, in particular the self-centering associated therewith. In particular, a new cutting edge segment to be used is in exactly the same position after reclamping as the previously used cutting edge segment was in.

In principle, the workpiece 102 and the tool 10 may also be interchanged and/or a kinematic reversal can be provided.

Individual aspects and features of the present invention may be implemented and advantageous independently, but also in any combination.

List of Reference Signs:

| | |
|---|---|
| 10 | Tool |
| 12 | Cutting insert holder |
| 12A | First portion |
| 12B | Second portion |
| 14, 14′ | Cutting insert |
| 16 | Machine interface |
| 18 | Front side |
| 19 | Upper side |
| 20 | First cutting insert receptacle |
| 22 | Second cutting insert receptacle |
| 23 | Receptacle region |
| 24 | First center axis |
| 26 | Second center axis |
| 28 | Clamping portion |
| 30, 30′ | Cutting portion |
| 32 | Rear stop surface |
| 34 | Counter abutment surface |
| 36 | Fixing means |
| 37 | Aperture |
| 38, 38′ | Thread |
| 39 | Gap |
| 40 | Imaginary crossing point |
| 42, 42′ | Cutting edge |
| 44, 44′ | First cutting edge segment |
| 46, 46′ | Second cutting edge segment |
| 48 | Height adjustment device |
| 50 | Aperture |
| 100 | Apparatus |
| 101 | Linear drive |
| 102 | Workpiece |
| 102A | Flat side |
| 103 | Workpiece spindle |
| 104 | Receptacle |
| 105 | Holder |
| 106 | Control device |
| 107 | Machine bed |
| α | Angle |
| C | Linear axis |
| W | Linear axis |
| X | Linear axis |
| Y | Linear axis |
| Z | Linear axis |
| t | Receptacle depth |

1. A tool for machining a workpiece, comprising:
a cutting insert; and
a cutting insert holder,
comprising a first cutting insert receptacle extending along a first center axis and a second cutting insert receptacle extending along a second center axis, into which the cutting insert is selectively receivable;
wherein the first and second center axes intersect at an imaginary crossing point located in a region that is covered by the cutting insert when the cutting insert is received in the first cutting insert receptacle as well as when the cutting insert is received in the second cutting insert receptacle.

2. The tool according to claim 1, wherein the cutting insert is fixable in two different positions on the cutting insert holder by being selectively received in one of the two cutting insert receptacles.

3. The tool of claim 1, wherein the first cutting insert receptacle is configured as a first receiving pocket into which the cutting insert is insertable along the first center axis from a front side of the cutting insert holder, wherein the second cutting insert receptacle is configured as a second receiving pocket into which the cutting insert is insertable along the second center axis from the front side of the cutting insert holder.

4. The tool according to claim 1, wherein the first and second cutting insert receptacles are each formed as at least substantially V-shaped recesses which partially overlap each other.

5. The tool according to claim 4, wherein the cutting insert is formed as a cutting plate.

6. The tool according to claim 1, wherein a shape of the first receiving pocket or first cutting insert receptacle is identical to a shape of the second receiving pocket or second cutting insert receptacle.

7. The tool according to claim 1, wherein the first center axis and the second center axis are aligned with respect to one another at an acute angle.

8. The tool according to claim 1, wherein the cutting insert is received or receivable in a self-centering manner in the cutting insert receptacles.

9. The tool according to claim 1, wherein the cutting insert has at least one cutting edge, wherein the at least one cutting edge has at least two cutting edge segments which are arranged equidistantly from the crossing point when the cutting insert is received in the first cutting insert receptacle as well as when the cutting insert is received in the second cutting insert receptacle.

10. The tool according to claim 9, wherein the two cutting edge segments each extend over at least 10% of a total length of the at least one cutting edge.

11. The tool according to claim 9, wherein the two cutting edge segments lie on a circular arc whose center coincides with the crossing point when the cutting insert is received in the first cutting insert receptacle as well as when the cutting insert is received in the second cutting insert receptacle

12. The tool according to claim 1, wherein the cutting insert holder comprises a or precisely one fixing means adapted to fix or clamp the cutting insert in the cutting insert holder when the cutting insert is received in the first cutting insert receptacle as well as when the cutting insert is received in the second cutting insert receptacle.

13. The tool according to claim 12, wherein the fixing means comprises a screw which can be screwed into a thread provided in the cutting insert holder.

14. The tool according to claim 1, wherein a height adjustment device is provided for adjusting the tip height of a cutting edge of the cutting insert.

15. The tool according to claim 1,
wherein
the first cutting insert receptacle is configured as a first receiving pocket into which the cutting insert is insertable along the first center axis from a front side of the cutting insert holder and has a first receptacle depth measured along the first center axis, and the second cutting insert receptacle is configured as a second receiving pocket, into which the cutting insert is insertable along the second center axis from the front side of the cutting insert holder and has a second receptacle depth measured along the second center axis, wherein a distance of the imaginary crossing point from the front side of the cutting insert holder is smaller than the first and the second receptacle depth.

16. The tool according to claim 1,
wherein the cutting insert has a cutting portion with at least one cutting edge for machining the workpiece and has a clamping portion for clamping in the cutting insert holder, wherein the clamping portion is rod-shaped.

17. A cutting insert holder for a tool for machining a workpiece, comprising:
a first cutting insert receptacle extending along a first center axis for receiving a cutting insert; and
a second cutting insert receptacle extending along a second center axis for receiving the cutting insert;
wherein the first center axis and the second center axis are aligned at an acute angle with respect to each other and intersect at an imaginary crossing point so that the cutting insert is selectively receivable in the first cutting insert receptacle or in the second cutting insert receptacle.

18. The cutting insert holder according to claim 17, wherein the first cutting insert receptacle is configured as a first receiving pocket into which the cutting insert is insertable along the first center axis from a front side of the cutting insert holder and has a first receptacle depth measured along the first center axis, and the second cutting insert receptacle is configured as a second receiving pocket, into which the cutting insert is insertable along the second center axis from the front side of the cutting insert holder and has a second receptacle depth measured along the second center axis.

19. The cutting insert holder according to claim 18, wherein a distance of the imaginary crossing point from the front side of the cutting insert holder is smaller than the first and the second receptacle depth.

20. The cutting insert holder according to claim 18, wherein the first and second receptacle depth are of equal size.

21. The cutting insert holder according to claim 17, wherein the first and second cutting insert receptacles are formed as at least substantially V-shaped recesses or as elongated depressions with non-round, or polygonal, cross-section.

22. The cutting insert holder according to claim 17, wherein the cutting insert holder comprises a height adjustment device for adjusting the height of the cutting insert holder when mounting to a machine.

23. The cutting insert holder according to claim 17, wherein the cutting insert has a cutting portion with at least one cutting edge for machining the workpiece and has a clamping portion for clamping in the cutting insert holder, wherein the clamping portion is rod-shaped.

24. The cutting insert for a tool for machining a workpiece, the cutting insert having a cutting portion, with at least one cutting edge for machining the workpiece and having a clamping portion for clamping in a cutting insert holder, wherein the clamping portion is rod-shaped.

25. The cutting insert according to claim 24, wherein the clamping portion is formed as a prism and/or has a non-round, or polygonal cross-section.
